(19) United States
(12) Patent Application Publication
(10) Pub. No.: US 2012/0174661 A1
(43) Pub. Date: Jul. 12, 2012

(54) METHOD OF OPTIMIZING A TIRE TREAD COMPOUND, AND A TIRE TREAD COMPOUND MADE BY SAID METHOD

(76) Inventors: William L. Hergenrother, Akron, OH (US); James D. Ulmer, Akron, OH (US); Christopher G. Robertson, Akron, OH (US)

(21) Appl. No.: 13/424,555

(22) Filed: Mar. 20, 2012

Related U.S. Application Data
(63) Continuation of application No. 11/098,952, filed on Apr. 5, 2005, now abandoned.

(51) Int. Cl. G01M 17/02; C08L 25/10; C08F 236/10

(52) U.S. Cl. 73/146; 525/332.9; 524/575

(57) ABSTRACT

The present invention relates to a methodology for determining various rubber composition factors that play a role in the structural and functional attributes of the rubber. The present invention also relates to tire treads that are derived using the methodology for optimizing the same as described herein.

### FIELD OF THE INVENTION

This invention relates to tire tread compounds and methods of analyzing the contributions of various components in cured rubbers to optimize tire tread compounds.

### BACKGROUND

The use of tin end capped elastomers to reduce the rolling resistance of tires has been an area of significant interest to the rubber industry for a number of years. See Tsutsumi et al, Rubber Tech., 63, 8 (1990), and Fujimaki et al., Proc. Int. Rubber Conf., Kyoto, Japan 184 (1985), both of which are herein incorporated by reference in their entirety. Generally, tin end capping has been accomplished by use of anionic techniques to polymerize a diene or a mixture of styrene and a diene with butyl lithium. The solution of the “living” lithium polydiene elastomer is then reacted with an active tin chloride reagent (Sn—Cl) to give a polymer with a tin functionality attached to one end group (H—Sn). Some Sn ends of the H—Sn polymer molecules react with the functionality of the carbon black (CB) used in the compound to provide elastomer with end attachments to the CB. See Hergenrother et al., J. Polym. Sci., Polym. Chem. Ed., 33, 143 (1995), herein incorporated by reference in its entirety. The attachments reduce hysteresis, both by Payne effect reduction and reduction of polymer chain ends. See Ulmer et al., Rubber Chem. Tech. 71, 637 (1998), herein incorporated by reference in its entirety.

More recently, the technology to produce a diene polymer in which both ends of the polymer have a tin functionality present has been developed. See U.S. Pat. No. 5,268,439; and Bethea et al., Rubber & Plastic News, 1994 Technical Notebook, Crain Communications, Inc., Akron, 1995 p. 73-76, all of which are herein incorporated by reference in their entirety. Such a synthesis has been accomplished by using tributyltin lithium as the polymerization initiator followed by the traditional termination technique with chlorostannanes. The preparation of a new class of elastomeric polymers (Sn—Sn) having tin functionality at each end is thus allowed.

The trapping of polymer entanglements between chemical crosslinks has been of interest for some time. The techniques used to study polymer entanglements, predominately on cured gums, include swelling, NMR, creep tests and mechanical spectrometry. See, e.g., Litivinov et al., Rubber Chem. Tech., 71, 105 (1998); Cholinska et al., Polimery (Warsaw, Poland), 22, 241 (1977); Gajewski, Polimery (Warsaw, Poland), 22, 241 (1977); Balwin et al., Rubber Chem. Tech., 45, 709 (1972); Vinogradov et al., Inter. J. Polymeric Materials, 3, 165 (1974); and Langley et al., J. Polym. Sci., Polym. Phys. Ed., 12, 1023 (1974), all of which are herein incorporated by reference in their entirety. Although each technique has limitations, the investigations found in general that increased polymer Mₙ increases the number of trapped entanglements, and that entanglements play a dominant role in the modulus of crosslinked polymers. However, the contributions of each of several individual components to modulus, including polymer entanglements, has not yet been comprehensively analyzed. As a result, the ability to optimize tire tread compounds has been limited.

### BRIEF SUMMARY OF THE INVENTION

The present invention relates to a methodology for determining various rubber composition factors that play a role in the structural and functional attributes of the rubber. The present invention also relates to tire treads that are derived using the methodology for optimizing the same as described herein.

The polymer-filler interactions developed with functional polymers have a profound effect on all of the types of effective network chains that are present in a cured elastomer. Three possibilities are considered: 1) the polymer has an increased crosslink density (νₑ) from the end linking to CB; 2) additional polymer entanglements are trapped by end linking to CB; and 3) a significant fraction of the polymer has a virtually infinite molecular weight due to end linking with CB.

In one aspect of this invention, Tensile Retraction (TR) can be applied to estimate the contributions of individual components to the total number of chain restrictions, and hence to modulus, in a rubber compound. TR appears to overcome some of the limitations associated with other techniques and can be applied at conditions where the polymer chains are not at their equilibrium configurations.

TR can be used to first estimate the numbers of chemical crosslinks and trapped entanglements in gum compounds cured to different levels. These findings can be then used to further probe the nature of polymer chain restrictions in carbon black filled compounds based on two different polymers: an SBR having terminal tin groups, and its non-functional counterpart terminated with H on both ends.

The use of TR has substantiated that effective network chains are formed not only from chemical reactions but also from the entrapment of the inherently entangled polymers between crosslinks. The N_{E} trapped by chemical crosslinking has been related to the concentration of accelerator ([TBBS]) by use of the entanglement model.

The γ intercept from TR was related to the molecular weight between entanglements, M_{e,} determined from the plateau region of the linear viscoelastic master curve on uncured gum rubber. The TR measurement was accomplished by extrapolation to a zero accelerator level of curatives in cured gums and comparing the results to those obtain by independent linear viscoelastic measurement of Mₑ. This technique can be applied to any curable elastomer.

This analysis enables the identification of various effective network chains that are present in a crosslinked network. Specifically, the process demonstrates the presence of chemically effective network chains between polymers and assigns the contribution of the trapped entanglements and now allows assignment of filler effects present in a filled elastomer. This can lead to the determination of the isolated contribution of chemical cure in any elastomer. Such data could be valuable in establishing the cure kinetics of elastomers by making TR measurements at different cure times as a function of the concentrations of reagents, type of rubber and cure temperature.

The entanglement model and the techniques described with the gum cures have been expanded to include the effect of carbon black loading on sulfur cured elastomers. The measurement of Mₑ on unvulcanized gum SBR assisted in the understanding of this expanded entanglement model so that the contribution of the number of effective network chains attributable to the filler introduced per polymer chain (N_{F}) could be assigned. This was applied to six different cure levels and four different CB loading with a non-functional polymer.

When a α,ω-difunctional SBR was used, a probability model was constructed to account for the number of effective network chains that the functional polymer introduced both by reaction with the filler and by increasing the number of entanglements that this reaction caused. A high reactivity of the functional end with filler was shown to be possible. The probability model showed that the extent of reaction of the end group with filler increases as the volume fraction of filler increases and showed some additional increase with increased vulcanization.

Three possible changes in contributions to crosslinking of Sn—Sn polymer over H—H polymer that were considered are all feasible. The total numbers of effective network chains/chain (N_{T}) were seen to increase with cure and filler level in all but the highest cure level of the most highly filled stock. This increase brought about a significant increase in the number of trapped entanglements (N_{E}) far disproportionate to the number of chain ends that reacted (N_{R}) with the filler. The effects of a greater N_{E} were ameliorated by a reduction in the physical interaction between filler particles (N_{F(Sn)}). The N_{F(Sn)}) decrease was attributable to the reaction of the allyl tin endgroups with the carbon black thereby decreasing the flocculation of the filler during processing and curing. The calculated N_{C}, N_{T}, N_{E}, and N_{F(Sn)} values may then be used to determine the probability of one chain end reacting with filler (π) and the probability (π²) that both chain ends react with the filler.

A significant change in the Sn—Sn elastomers lies in the type of network that was formed after sulfur curing of a carbon black loaded stock. The high probability (π²) that was measured from the reaction of two allyl tin end groups per chain with filler could be viewed as leading to the formation of a significant fraction of linear polymer with a virtual infinite molecular weight (e.g. having no end groups) as a component in the cured stock. The fashion in which this occurs most reasonably should generate a sizable fraction of the Sn—Sn polymer being end linked into a network by the reaction of the polymer at both ends to the essentially non-mobile filler phase. The π²allowed the assignment of the fraction of polymer chains that reacted with CB at both ends. Preferably, the π²value is greater than about 0.04, more preferably greater than about 0.35, and most preferably greater than about 0.50.

For 57 phr CB at the three highest levels of chemical crosslinking, π²is about 0.25. This means that about 25% of the terminal di-functional SnSn polymers are attached at both ends to CB. Other methods of modifying the chemical crosslink density are known to one skilled in the art, and would be acceptable for the purposes of this invention.

The rubber chemist now has at his disposal a new approach, which can potentially determine the number of effective network chains arising from each of several sources. Knowledge of the contributions from individual effective network chain sources allows probing their individual influences on rubber properties. This can be applied to functional or non-functional polymers and offers the possibility to assess the contributions to physical properties due strictly to effective network chains from chemical cure, entanglements, interaction of polymer chains with filler and reaction of terminal end groups with filler. Such information will allow the various kinetic parameters to be determined and quantified for any cured elastomer.

An embodiment of the invention relates to a method of optimizing a tread compound, comprising the steps of: (a) providing a rubber composition comprising at least one functionalized polymer and at least one filler; (b) creating at least one set of tensile retraction curves, each set comprising at least two tensile retraction curves from the rubber composition, wherein said curves are generated from elongation values ranging from about 0.5% elongation to a maximum elongation of about 10% less than the elongation at break; and (c) calculating rubber composition factors from the set of tensile retraction curves, wherein the rubber composition factors comprise a trapped entanglements value (N_{E}), a chemical crosslink value (N_{C}), and a filler-filler-polymer interaction value (N_{F}).

Another embodiment of the invention relates to a method of preparing an end-functionalized polymer for use in an optimized tread compound, the method comprising the steps of: (a) providing a rubber composition comprising at least one functionalized polymer and at least one filler; (b) creating at least one set of tensile retraction curves, each set comprising at least two tensile retraction curves from the rubber composition, wherein said curves are generated from elongation values ranging from about 0.5% elongation to a maximum elongation of about 10% less than the elongation at break; (c) calculating from the set of tensile retraction curves at least one rubber composition factor, wherein the rubber composition factors comprise a trapped entanglements value (N_{E}), a chemical crosslink value (N_{C}), and a filler-filler-polymer interaction value (N_{F}); and (d) preparing a end-functionalized polymer for use in an optimized tread, wherein at least one of the rubber composition factors has been used to develop the end-functionalized polymer.

It is also an aspect of the invention to provide a tire tread polymer that has been optimized using the methodologies taught herein. In one embodiment, the invention relates to a difunctional polymer wherein both ends of the difunctional polymer sufficiently react with a filler to produce a π²value greater than about 0.04. In another embodiment, the invention relates a rubber tread for a tire having a composition comprising a polymer and a filler, the polymer having (a) a trapped entanglement value (N_{E}) ranging from about 10 to about 40 per polymer chain; (b) a chemical crosslink value (N_{C}) ranging from about 2 to about 10 per polymer chain; and (c) a filler-filler-polymer interaction value (N_{F}) ranging from about 10 to about 15 restrictions per polymer chain.

### BRIEF DESCRIPTION OF THE DRAWINGS

FIG. 1a—This figure illustrates a determination of Mᵣ from TR of polymer A filled with 43 phr CB and cured with 0.5 phr TBBS and 0.75 phr sulfur.

FIG. 1b—This figure illustrates a determination of β from TR of polymer A filled with 43 phr CB and cured with 0.5 phr TBBS and 0.75 phr sulfur.

FIG. 1c—This figure illustrates a determination of γ from TR of polymer A filled with 43 phr CB and cured with 0.5 phr TBBS and 0.75 phr sulfur.

FIG. 2—This figure illustrates a determination of Mₑ from viscoelastic master curve data for Polymer A.

FIG. 3—This figure illustrates N_{F}, the number of moles of effective network chains due to filler from the subtraction of the N_{T, gum} from the N_{T, CB} of the filled polymer A. In the figure, ΔN_{T} or N_{F} is shown versus [TBBS], where the CB level for ♦ is 57 phr, ▪ is 43 phr, ▴ is 31 phr, and × is 19 phr.

FIG. 4—This figure illustrates a graphical determination of Mₑ from the γ intercepts from TR determined from a series of gum cures on both H—H and Sn—Sn polymers (A and B). The zero accelerator intercept of −3.5216 was obtained from a quadratic fit and corresponds to a Mₑ of 3.32 kg/mol.

FIG. 5—This figure illustrates a plot of the types of effective network chains determined in gum vulcanized A where N_{T} is ♦, N_{C} is ▪ and N_{E} is ▴using Eqn 3. The value of Mₑ was determined to be 3.13 kg/mol from the fitted equations for N_{T}=−0.5175x²+7.1284x+9.9166 with R²=0.9906, N_{E}=−0.4485x²+5.962x+8.861 with R²=0.9891 and N_{C}=2.1548x^{0.53333} with R²=0.9926.

FIG. 6—This figure illustrates N_{F}, the number of moles of effective network chains due to filler from the subtraction of the N_{T, gum} from the N_{T, CB} of the filled polymer A. In the figure, ΔN_{T} or N_{F} is shown versus [TBBS], where the CB level for ♦ is 57 phr, ▪ is 43 phr, ▴ is 31 phr, and × is 19 phr.

FIG. 7—This figure illustrates the average probability π that a tin end group reacted with filler.

FIG. 8—This figure illustrates the individual probability of polymer-filler reaction (π) calculated from Eqn 14 for B obtained by substituting the average quotient obtained from the TR β ratio times N_{F(H)} to give N_{F(Sn)}. The values of π calculated versus [TBBS] are shown where the CB level is 57 phr for ♦, 43 phr for ▪, 31 phr for ▴, and 19 phr for ×.

FIG. 9—This figure illustrates the crosslink distribution for an Sn—Sn (B) polymer filled with 57 phr CB where N_{T} is ♦, N_{C} is ▪, N_{F(Sn)} is ▴, N_{F(Sn)} is × and N_{R} is *.

FIG. 10—This figure illustrates the crosslink distribution for B filled with 43 phr CB where N_{T} is ♦, N_{C} is ▪, N_{F(Sn)} is ▴, N_{E,π} is × and N_{R} is *.

FIG. 11—This figure illustrates the crosslink distribution for B filled with 31 phr CB where N_{T} is ♦, N_{C} is ▪, N_{F(Sn)} is ▴, N_{E,π} is × and N_{R} is *.

FIG. 12—This figure illustrates the crosslink distribution for B filled with 19 phr CB where N_{T} is ♦, N_{C} is ▪, N_{F(Sn)} is ▴, N_{E,π} is × and N_{R} is *.

FIG. 13—This figure illustrates the difference obtained by subtracting the specific number of crosslink/polymer chain of a H—H polymer (A) from those measured in an Sn—Sn polymer (B) containing 57 phr CB where N_{T} is ♦, N_{C} is ▪, N_{E} is ▴, N_{F} is × and N_{R} is *.

FIG. 14—This figure illustrates the difference obtained by subtracting the specific number of crosslink/polymer chain of a H—H polymer (A) from those measured in an Sn—Sn polymer (B) containing 43 phr CB where N_{T} is ♦, N_{C} is ▪, N_{E} is ▴, N_{F} is × and N_{R} is *.

FIG. 15—This figure illustrates the difference obtained by subtracting the specific number of crosslink/polymer chain of a H—H polymer (A) from those measured in an Sn—Sn polymer (B) containing 31 phr CB where N_{T} is ♦, N_{C} is ▪, N_{E} is ▴, N_{F} is × and N_{R} is *.

FIG. 16—This figure illustrates the difference obtained by subtracting the specific number of crosslink/polymer chain of a H—H polymer (A) from those measured in an Sn—Sn polymer (B) containing 19 phr CB where N_{T} is ♦, N_{C} is ▪, N_{E} is ▴, N_{F} is × and N_{R} is *.

### DETAILED DESCRIPTION OF THE INVENTION

The TR test set consists of at least two tensile retractions tests, each to a progressively higher target extension ratio, Λₘₐₓ, followed immediately by a retraction to zero stress. Each tensile pull and subsequent retraction are done at the same testing rate such that a series of extension and retraction curve pairs are obtained. During each retraction, the stress, σ, is measured as a function of extension ratio, Λ, defining the tensile retraction curve. Testing was performed in accordance with the procedures outlined in Hergenrother, J. Appl. Polym. Sci., 32, 3039 (1986), herein incorporated by reference in its entirety.

For compounds containing rigid filler, the enhancement of modulus due to rigid particles is taken into account in a fashion similar to that of Harwood and Payne, J. Appl. Polym. Sci., 10, 315 (1966) and Harwood, Mullins and Payne, J. Appl. Polym. Sci., 9, 3011 (1965), both of which are herein incorporated by reference in their entirety. When a filled compound is first stretched in tension to the same stress as its corresponding gum compound, subsequent retraction and extension curves are generally very similar to those of the gum compounds when stress is graphed as a function of normalized strain. Normalized strain is defined as the strain at any point on the subsequent extension or retraction curves divided by the maximum strain of the initial extension. For retraction curves in particular, and for maximum strains of the NR gum compound up to and including near breaking strain, this could be applied to a number of filled compounds, each differing in carbon black type. The result is interpreted as evidence of strain amplification of the polymer matrix by carbon black, where the average strain in the polymer matrix of a filled compound is the same as that in the corresponding gum compound, when the filled and gum compounds are compared at the same stress.

The strain amplification, X, was taken for thermal black to be given by the Guth-Gold equation, X=1+2.54φ+14.1φ², where φ is the volume fraction of filler. See Mullins et al., J. Appl. Polym. Sci., 9, 2993 (1965) and Guth et al., Phys. Rev., 53, 322 (1938), both of which are herein incorporated by reference in their entirety. Consequently, Λ of the current tensile retraction experiments has been taken for carbon black filled compounds as Λ=l+Xε, where X is the Guth-Gold equation. The strain, ε, is taken as (l−lₛₑₜ)/Iₛₑₜ, where l is the specimen length at any point on the retraction curve, and lₛₑₜ is the specimen length after retraction to zero stress.

After correction of A for filler level, neo-Hookean rubber elasticity theory (see e.g., Shen, Science and Technology of Rubber, Academic Press, New York, 1978, 162-165) may be applied to an internal segment of the retraction curve, from which a molecular weight between chain restrictions of all types, Mᵣ, is computed. Mᵣ is calculated according to:

$${M}_{r} = \frac{ρ RT ( Λ - {Λ}^{- 2} )}{σ} \qquad ( 1 )$$

where Mᵣ is the molecular weight between polymer chain restrictions of all types, ρ is the compound density, σ is stress, R is the gas constant, T is temperature and Λ is 1+Xε. The extension ratio of a single retraction curve is identified by Λₘₐₓ. Extension of the same rubber specimen to successively higher Λₘₐₓ provides Mᵣ as a function of Λₘₐₓ.

Three processes related to strain are thought to occur in a tensile retraction experiment. When viewed from the perspective of increasing strain, any higher strain process is superimposed on the process being described. Thus, the first process is the elimination of temporary entanglements, originally located along the length of ineffective network chains—polymer backbone segments terminated at one end with a chemical cross-link, but which are free at the other end—by extending the rubber specimen to elongations less than or equal to about 6%.

The second process, seen in the elongation range of from about 6% minimum to about 40% to 80% maximum, involves the 1) breaking of the weak filler-filler linkages described by the Payne effect as well as 2) the interactions of the polymer with the filler brought about by chemical reactions and increased mix energy. See U.S. Pat. No. 6,384,117, herein incorporated by reference in its entirety.

The third process is the slipping of permanent entanglements, located along the length of effective network chains, while the entanglements themselves remain trapped between the chemical crosslinks at each effective strand end. In other words, increased slippage of entanglements trapped between crosslinks is thought to occur with increasing Λₘₐₓ. The slippage that occurs during extension to successively higher Λₘₐₓ, then, leads to a reduced modulus upon retraction.

Since the entanglements associated with ineffective network chains are eliminated upon extension to elongation at greater than about 6%, extrapolation of the linear portion of Mᵣ vs. Λₘₐₓ, which is based on the retraction curve, to Λₘₐₓ=1 captures the effect of entanglements for those entanglements that are trapped between cross-links. In addition, since slippage of permanent entanglements might be thought to increase with increasing Λₘₐₓ, extrapolation of the linear portion of Mᵣ vs. Λₘₐₓ above about 40 to 80% elongation to Λₘₐₓ=1 captures the state of trapped entanglements in the rubber before its deformation. Consequently, the molecular weight between chain restrictions, M_{c}=Mᵣ when Λₘₐₓ=1, includes the contribution to the total number of chain restrictions of only those entanglements that are trapped. Finally, the trapped entanglement contribution is captured when the rubber is in its initial, unperturbed state.

As known to those in the art, elongation values may be generated from tensile retraction curves. The values may be generated at low elongation levels, such as 0.5%, to high elongation levels, such as those measured up to the breaking point. As different compounds have different breaking points, the maximum elongation will vary depending on the breaking point of the particular compound, in some cases 300% or higher. Elongation values measured at 0.5% elongation to 10% less than the elongation at break will provide a skilled artisan with sufficient values to create, for instance, tensile retraction curves from the data.

### Experimental

Polymer Synthesis

Two SBR polymers with nearly identical microstructure, molecular weight and polydispersity were prepared. The difunctional polymer (Sn—Sn) was initiated with tributyltin lithium (TBTL) and terminated with tributyltin chloride. The non-functional polymer (H—H) was initiated with butyl lithium and was quenched with alcohol. These rubbers were prepared in a 20-gal reactor by standard batch techniques. The H—H batch polymer (A) prepared by standard anionic techniques was used as an example of a typical SBR polymer. An almost identical Sn—Sn polymer (B) was also prepared so that meaningful comparisons could be made with A. The characterization of these elastomers by NMR, GPC and DSC is listed in Table I.

TABLE I
Polymer Characterization

Polymer

| | A | B |
|---|---|---|
| % Styrene | 20.7 | 20.4 |
| % Vinyl PBD | 40.3 | 39.7 |
| T_{g}, ° C. | −47.2 | −46.2 |
| Mₙ, kg/mol | 163.5 | 160.0 |
| M_{w}/Mₙ | 1.077 | 1.11 |
| Initiator | Butyl Li | Tributyltin Li |
| Terminator | H | Tributyltin |

Polymer Characterization

Gel permeation chromatography (GPC) measurements were carried using a Waters WISP System, including a Model 410 Refractometer, with tetrahydrofuran (THF) as the solvent. Solid samples were weighed, dissolved in THF, and filtered before injection onto the GPC columns. Molecular weights were calculated from a universal calibration curve based on polystyrene standards. Proton NMR measurements were made with a 300 MHz Varian Gemini 300, with the polymer samples dissolved in deuterated chloroform. The T_{g} was measured by differential scanning calorimeter (TA Instruments, Model 910). The T_{g} was taken as the midpoint of the glass transition.

Compound Preparation

Rubber compounds were prepared with different levels of N343 carbon black (CB), sulfur and accelerator. The CB levels were 0, 19.4, 30.66, 43.18 and 57.2 phr. The levels were chosen to give evenly spaced CB volume fractions of 0.0883, 0.1325, 0.1783 and 0.2229. The weight ratio of sulfur to tert-butyl benzothiazole sulfenamide (TBBS) was held constant at 1.5, while the sulfur was varied from 0.25 to 1.5 phr. The master batch mixing stage was carried out in a 300-g Brabender with a discharge temperature of 171° C. Master batch ingredients included 100 phr SBR, 2 phr stearic acid, 3 phr zinc oxide, 1 phr antioxidant and varied levels of CB. Curatives were added on a 100° C. mill, and then the stocks were cured at 171° C. The time to 90% cure, t₉₀, as measured with the Monsanto Rheometer, was used to select cure times. The t₉₀ values ranged from 6.5 to 50 minutes, depending primarily upon [TBBS]. Cure times were chosen as ten minutes more than t₉₀ rounded to the next highest multiple of five minutes.

Tensile Retraction

The rubber compounds were cured in a special ribbed TR mold to prevent slippage when stretched in tension between clamps of an Instron 1122 tester controlled by a Hewlett Packard 9836 computer that was used for testing, data acquisition and calculations. See Hergenrother, J. Appl. Polym. Sci., 32, 3039 (1986), herein incorporated by reference in its entirety. Specimens were nominally 12 mm wide by 50 mm long by 1.8 mm thick. The ZnO was considered to be rigid filler in Eq. 1 for both the gum and carbon black loaded compounds. This resulted in the gum stock value of X being about 2% greater than unity, while X of the carbon black loaded compounds is somewhat larger than what would be obtained if carbon black was taken to be the only source of rigid particles.

For each retraction on a single specimen, Mᵣ was calculated at each of 25 (σ, Λ) data pairs, collected from about the middle one-third of the particular retraction curve. The Mᵣ value reported for each retraction curve is the average of the 25 calculated values, and is associated with an extension ratio, Λₘₐₓ, corresponding to the maximum extension ratio of the particular retraction curve.

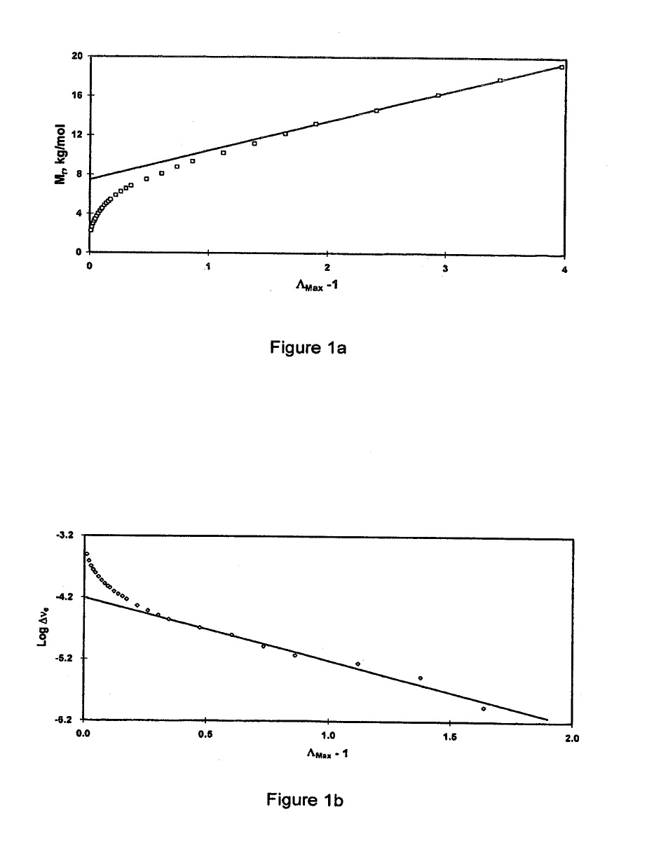

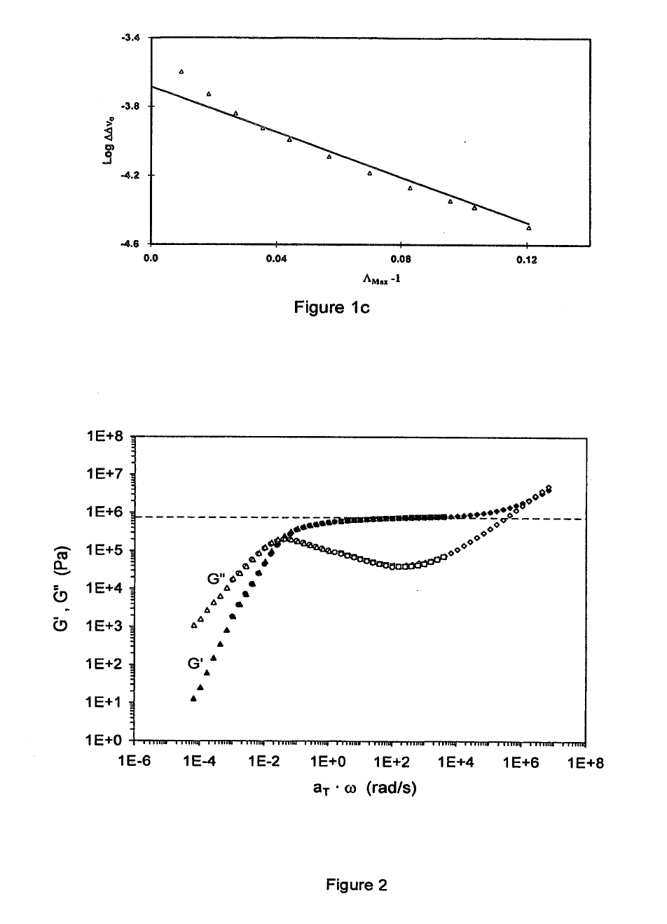

In order to reduce test time, elongations to successively higher Λₘₐₓ were carried out at successively higher speeds of the Instron crosshead motion. A master TR curve was obtained by shifting the different test speeds to a standardized testing rate of 5%/min. See Hergenrother, J. Appl. Polym. Sci., 32, 3683 (1986), herein incorporated by reference in its entirety. The high strain (greater than about 40% to 80% Elongation) region of the smooth curve thus obtained was fitted by a linear equation of the form of Mᵣ=S(Λₘₐₓ−1)+M_{c}. Typical data for polymer A loaded with 43 phr CB and cured with 0.75 phr sulfur and 0.50 phr of accelerator may be seen in FIG. 1a. The fit to the strain region at less than 80% elongation can be seen as deviating steadily from the Mᵣ line as strains were progressively reduced. The logarithm of this difference between the calculated and observed νₑ was then plotted versus the lower level of strain (FIG. 1b) to give a linear fit to Δνₑ=s (Λₘₐₓ−1)+m. The antilog of the reciprocal of the intercept, m, has been denoted as β (expressed in kg/mol) and relates to the micro-dispersion of the filler. See U.S. Pat. No. 6,384,117, herein incorporated by reference in its entirety. In a similar fashion the lowest strain deviation was treated to give a plot of ΔΔνₑ as a function of (Λₘₐₓ−1). See FIG. 1c. The antilog of the reciprocal of the intercept for the process that occurs at strains of less than 6% elongation has been denoted as γ (expressed in kg/mol).

The three equations, each with a slope and intercept, that are used to fit the various strain regions of the TR curve were summed to provide a single master equation¹⁴ that empirically describes the Mᵣ response over the entire range of testing. See Hergenrother, J. Appl. Polym. Sci., 32, 3039 (1986), herein incorporated by reference in its entirety. The six experimentally constants of the new master equation were adjusted by using Excel Solver® to obtain the best possible fit of the predicted values to the experimentally values obtained by TR. The fitting criteria consisted of a slope of one and a zero intercept, when the experimental and curve fit values of Mᵣ were compared. The r² obtained was 0.999 or better. The reason this refinement was used is that the previous procedure for TR data analysis required that the transition between different strain regions be determined at a specific experimental strain level used in the experiment. The composite equation now allows the transition between each fitted linear region to be independent of the choice of the experimental strains measured. This small mathematical adjusting of the strain range allows a more precise linear fit of the data to be made. Only very small corrections in the three slopes and intercepts related to the Mᵣ fit were seen by this treatment.

Dynamic Mechanical Spectroscopy to Determine Mₑ

A Rheometrics Scientific ARES was used to evaluate the linear viscoelastic characteristics of the uncured gum polymers, from which the molecular weight between polymer chain entanglements, Mₑ, was determined. Parallel plate geometry was used to conduct isothermal frequency sweeps at −30, 0, 25, and 75° C. in a nitrogen-purged environment. At −30° C., 15 mm diameter plates were used and 25 mm diameter plates were used for the higher temperatures. Typical gaps ranged from 1.5 to 2 mm. A strain of 2%, calculated at the peripheries of the disk-shaped specimens, was used. Selective strain sweeps demonstrated that all reported measurements were within the linear viscoelastic region. The time-temperature superposition principle was applied to construct master curves at 25° C. reference temperature encompassing the transition zone through terminal flow in order to define the entanglement plateau region.

Mₑ was calculated from the plateau modulus, G_{N}, where G_{N} was estimated in two ways. For the first estimate, G_{N} is taken as the storage modulus when tan δ is a minimum. See Wu, Polymer, 28, 1144 (1987), herein incorporated by reference in its entirety. The second G_{N} estimate is based on the empirical relationship developed for nearly monodisperse polymer chains: G_{N}=3.56G″ₘₐₓ, where G″ₘₐₓ is the maximum loss modulus in the terminal relaxation peak. See Raju et al., Macromolecules, 14, 1668 (1981), herein incorporated by reference in its entirety.

Both methods provided essentially the same G_{N}, and the average G_{N} of the two methods was used to calculate Mₑ according to Mₑ=ρRT/G_{N}. See Ferry, Viscoelastic Properties of Polymers, John Wiley & Sons, New York, 1980, 3d Ed., p. 408-11, herein incorporated by reference in its entirety. Mₑ was determined to be 3.13 kg/mol for Polymers A (FIGS. 2) and 3.20 kg/mol for Polymer B. The values are consistent with the Mₑ reported of 3.00 kg/mol for a SBR with 23.5% styrene. See Mancke et al., Trans. Soc. Rheol., 12, 335 (1968), herein incorporated by reference in its entirety.

Other Physical Properties

Strain sweeps from 0.25% to 14.5% strain (½ peak-to-peak) at 25° C. and 0.5 Hz were performed on cured cylindrical specimens using the Rheometrics RDA II. The cylindrical specimens, about 1.55 cm high by 0.91 cm in diameter, were cured at the same conditions used to prepare the TR specimens and rubber plaques.

Tensile properties were measured at 25° C. on specimens cut from 1.9 mm×152.4 mm×152.4 mm plaques. Filled samples were cut into 17.5 mm diameter rings (OD) at a width of 0.95 mm, while dumbbell shaped specimens were die cut for gum compounds. All tests were conducted according to ASTM Method D 412.

Tensile Retraction Measurements

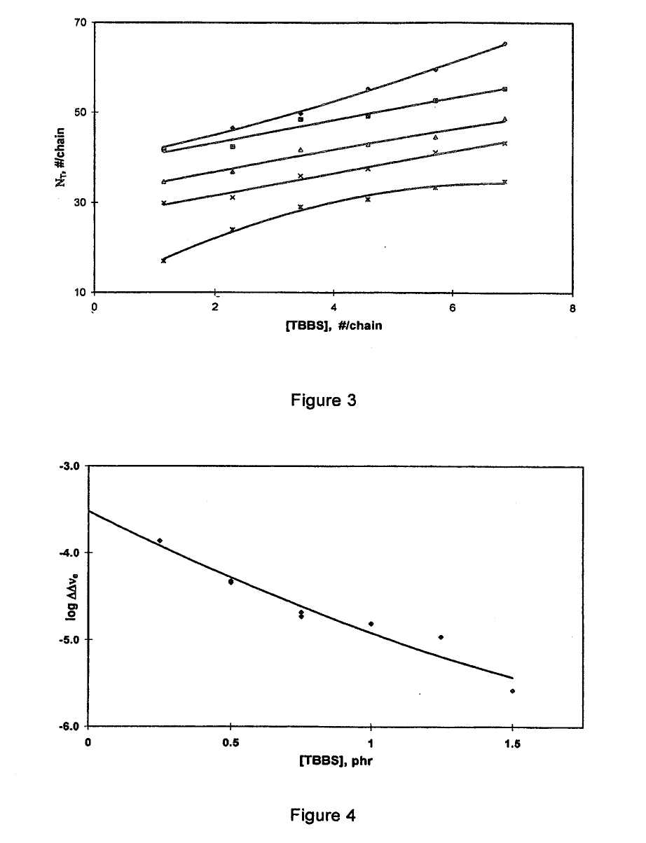

The molecular weight between crosslinks, M_{c}, was determined by in accordance with previously published procedures. See, e.g., Hergenrother, J. Appl. Polym. Sci., 32, 3683 (1986), herein incorporated by reference in its entirety. The Λₘₐₓ=1 intercept was used, except for when the factor X is not included in the denominator on the right side of Eq. 1. The reported M_{c}, refers not only to chemical crosslinks, but also to chain restrictions of all kinds. TR values of the moles of effective network strands/m³ of polymer, ν=ρ/M_{c}, and of β and γ, in units of kg/mol are summarized in Tables II and III for polymers A and B, respectively. Each of the listed TR parameters, νₑ, γ and β are characteristic of restricted chain motion. The tables include every combination of [TBBS] and carbon black level of the current study. The νₑ values for Polymer A shown in FIG. 3 gave the expected steady increase both as the sulfur-accelerator level and the carbon black loading increase.

TABLE II
TR measured νₑ, β and γ for Polymer A
at Varied Curative and Carbon Black Levels

| | TBBS, phr | | | | | |
|---|---|---|---|---|---|---|
| | 0.17 | 0.33 | 0.50 | 0.67 | 0.83 | 1.00 |
| | S, phr | | | | | |
| CB, phr | 0.25 | 0.50 | 0.75 | 1.00 | 1.25 | 1.50 |

νₑ = ρ/(M_{c}), mol/m³

| | | | | | | |
|---|---|---|---|---|---|---|
| 57.2 | 247.7 | 274.1 | 293.3 | 326.4 | 351.9 | 387.6 |
| 43.2 | 244.5 | 249.5 | 285.2 | 289.8 | 310.7 | 327.0 |
| 30.7 | 203.9 | 217.6 | 246.4 | 253.5 | 263.8 | 288.4 |
| 19.4 | 176.1 | 183.6 | 212.0 | 221.5 | 243.3 | 255.9 |
| 0.0 | 100.0 | 141.6 | 171.4 | 181.6 | 197.4 | 205.6 |

β, kg/mol

| | | | | | | |
|---|---|---|---|---|---|---|
| 57.2 | 17.13 | 12.36 | 12.40 | 11.29 | 9.13 | 7.81 |
| 43.2 | 49.33 | 17.45 | 16.03 | 12.26 | 10.87 | 10.43 |
| 31.7 | 70.05 | 30.47 | 21.12 | 18.26 | 17.58 | 17.65 |
| 19.4 | 22.72 | 36.80 | 46.28 | 26.59 | 29.27 | 35.39 |
| 0.0 | 21.95 | 22.29 | 42.98 | 34.99 | 125.19 | 77.23 |

γ, kg/mol

| | | | | | | |
|---|---|---|---|---|---|---|
| 57.2 | 4.25 | 5.40 | 4.76 | 5.19 | 5.18 | 4.81 |
| 43.2 | 5.10 | 4.31 | 4.85 | 4.70 | 5.60 | 5.27 |
| 31.7 | 5.72 | 8.70 | 8.40 | 12.97 | 14.14 | 13.91 |
| 19.4 | 13.14 | 15.05 | 19.48 | 25.80 | 25.34 | 36.19 |
| 0.0 | 7.29 | 21.16 | 53.93 | 0.24 | 91.42 | 37.10 |

TABLE III
TR measured νₑ, β and γ for Polymer B
at Varied Curative and Carbon Black Levels

| | TBBS, phr | | | | | |
|---|---|---|---|---|---|---|
| CB, phr | 0.25 | 0.50 | 0.75 | 1.00 | 1.25 | 1.50 |

νₑ = ρ/M_{c}, mol/m³

| | | | | | | |
|---|---|---|---|---|---|---|
| 57.2 | 242.2 | 275.1 | 326.5 | 335.0 | 379.1 | 380.2 |
| 43.2 | 208.4 | 253.3 | 299.2 | 329.6 | 344.6 | 379.3 |
| 30.7 | 171.1 | 210.7 | 250.4 | 270.2 | 286.1 | 315.8 |
| 19.4 | 155.7 | 200.1 | 221.8 | 240.7 | 243.2 | 270.8 |
| 0.0 | 85.5 | 146.2 | 176.0 | 192.3 | 205.1 | 215.0 |

β, kg/mol

| | | | | | | |
|---|---|---|---|---|---|---|
| 57.2 | 25.33 | 30.84 | 29.18 | 22.85 | 20.89 | 15.98 |
| 43.2 | 51.54 | 45.02 | 41.13 | 42.53 | 32.78 | 60.74 |
| 30.7 | 69.78 | 68.87 | 50.83 | 52.09 | 48.35 | 83.39 |
| 19.4 | 66.24 | 45.80 | 56.05 | 44.84 | 63.47 | 76.08 |
| 0 | 26.26 | 28.12 | 55.28 | 53.84 | 90.34 | 146.55 |

γ, kg/mol

| | | | | | | |
|---|---|---|---|---|---|---|
| 57.2 | 9.37 | 9.91 | 11.10 | 15.64 | 13.25 | 11.40 |
| 43.2 | 12.81 | 14.97 | 23.75 | 23.45 | 37.03 | 33.98 |
| 30.7 | 13.57 | 22.21 | 34.20 | 44.60 | 79.87 | 193.72 |
| 19.4 | 12.73 | 24.40 | 40.18 | 30.70 | 43.03 | 71.80 |
| 0 | 7.27 | 22.30 | 48.29 | 64.84 | 44.18 | 381.22 |

Chain Restrictions in Gum Compounds

The total number of effective network strands, N_{T}, is expressed as number per polymer molecule, where N_{T}=νₑMₙ/ρ. The values of N_{T} are shown for polymer A gum compounds in Table IV can be expressed as a sum of two components. One component is the number of effective network strands per polymer chain, N_{C}, due to chemical crosslinks, and the other is the number of effective network strands per polymer chain due to trapped polymer entanglements, N_{E}. That is,

N_{T}=N_{E}+N_{C}, (2)

where N_{E} depends on both the polymer type and its state of cure. For a non-functional gum polymer, Eq. 2 includes all of the chain restrictions that are involved in the sample.

TABLE IV
Calculated concentrations in Polymer A Cured Gum Compound

| TBBS | [Sulfur] | [TBBS] | N_{T} |
|---|---|---|---|
| phr | #/chain | #/chain | #/chain |
| 0.17 | 6.74 | 1.14 | 16.943 |
| 0.33 | 13.48 | 2.28 | 23.990 |
| 0.50 | 20.22 | 3.43 | 29.047 |
| 0.67 | 26.96 | 4.57 | 30.772 |
| 0.83 | 33.70 | 5.71 | 33.441 |
| 1.00 | 40.44 | 6.85 | 34.840 |

Starting with one chemical crosslink site on a linear polymer chain, each additional chemical crosslink site creates one additional effective network strand. That is, N_{C}=n−1, where n is the number of chemical crosslink sites per polymer chain. With respect to the entanglement contribution, N_{E} is the total number of entanglements per polymer molecule multiplied by the trapping factor φₜ, where,

$${φ}_{t} = {( \frac{n - 1}{n + 1} )}^{2} \qquad ( 3 )$$

Ferry, Viscoelastic Properties of Polymers, John Wiley & Sons, New York, 1980, 3d Ed., p. 408-11, or Rancke et al., J. Polym. Sci., Part A-2, 6, 1783 (1968), both of which are herein incorporated by reference in their entirety. Eq. 3 supposes that no entanglements are trapped unless there is more than one cross-link site on average per polymer molecule, and that successively larger n would trap (1/3)², (2/4)², (3/5)², etc. of the total number of entanglements per polymer molecule. Consequently, Eq. 3 is inapplicable for n<1. However, since the compounds of the current study are crosslinked well past the gel point (well past n=1), Eq. 3 was used as the trapping factor instead of the more complicated expression. See Langley, Macromolecules, 1, 348 (1968), herein incorporated by reference in its entirety.

The number of entanglement sites per polymer molecule is Mₙ/Mₑ−1, where Mₑ was measured as described in the Experimental section, and where Mₙ is number average molecular weight of the polymer. Thus,

$${N}_{E} = {( \frac{n - 1}{n + 1} )}^{2} ( \frac{{M}_{n}}{{M}_{e}} - 1 ) \qquad ( 4 )$$

Now Eq. 2 can be rewritten by replacing N_{C} with n−1 and Eq. 4 for N_{E} to give Eq. 5 for N_{T}:

$${N}_{T} = ( n - 1 ) + ( \frac{{M}_{n}}{{M}_{e}} - 1 ) {( \frac{n - 1}{n + 1} )}^{2} \qquad ( 5 )$$

As described in the Experimental section, Mₑ was determined to be 3.13 kg/mol for polymer A (FIGS. 2), and 3.20 kg/mol for polymer B. A similar value of Mₑ=3.32 kg/mol is obtained for combined data from the cured gums of polymers A and B by extrapolation of the logarithm of the reciprocal of selected values of γ to the zero [TBBS] intercept. See FIG. 4.

Although the Rheometrics determination of Mₑ was used for subsequent calculations, the logarithm of the (1/γ) intercept, which is the ΔΔνₑ as measured by TR, may also be used to estimate Mₑ. Both the viscoelastic measurements on the uncured gum compound and the extrapolated value of log (1 /γ) represent the restrictions that contribute to the modulus of a cured rubber sample at very low strain levels.

With N_{T}=νₑMₙ/ρ available from TR and with Mₑ measured from the mechanical spectra of the uncured gum compounds, n may be determined as a function of [TBBS] through Eq. 5. However, a model relating n to [TBBS] is first assumed. The model, n=a[TBBS]^{b}, was found to provide a good description of the experimental data. A non-linear least squares fit for A gave n=3.134[TBBS]^{0.426}, when N_{C}=n−1 was graphed as a function of [TBBS], as shown in FIG. 5. With the dependence of n on [TBBS] determined, the contributions of N_{C} and N_{E} to N_{T} can be calculated at each experimental [TBBS]. See FIG. 5.

All of the TR data were normalized to a 5%/min strain rate. The intercept data are dependent upon this strain rate.

Determination of Filler Contributions to N_{T}: Entanglement Model

Reinforcing fillers are known to provide significant contributions to the physical properties of a cured elastomer. Multiple phenomena are associated with reinforcing fillers, including strain amplification of the polymer matrix (as described by the Guth-Gold equation), the presence of a particle network above percolation (the Payne effect), and restriction of polymer chain motions near the particle surfaces. Strain amplification has been introduced into the analysis through Λ=1+Xε.

Thus far, chain restrictions due to filler, which may act like additional effective network chains, have yet to be incorporated into the analysis. For this, Eq. 4 is modified to include a filler interaction term in addition to the entanglement and chemical crosslinking contributions. This modification is shown in Eq. 6. For the non-functional polymer A, the interaction term is labeled N_{F(H)}, where N_{F(H)} is the number of effective network chains per polymer molecule attributable to the filler-filler and polymer-filler interaction (filler-filler-polymer interactions). The N_{F(H)} term includes the additional polymer chain restrictions due to entanglements that are trapped by these new restrictions.

N_{T}=N_{C}+N_{E}+N_{F(H)} (6)

Assuming the values of Mₑ, N_{E} and N_{C} that have been determined from the gum cures, the value of N_{F(H)} can be calculated as the difference between the N_{T} of the cured filled rubber and the identically cured gum (Eq. 7).

N_{F(H)}=ΔN_{T}=N_{T, fil}−N_{T, gum} (⁷)

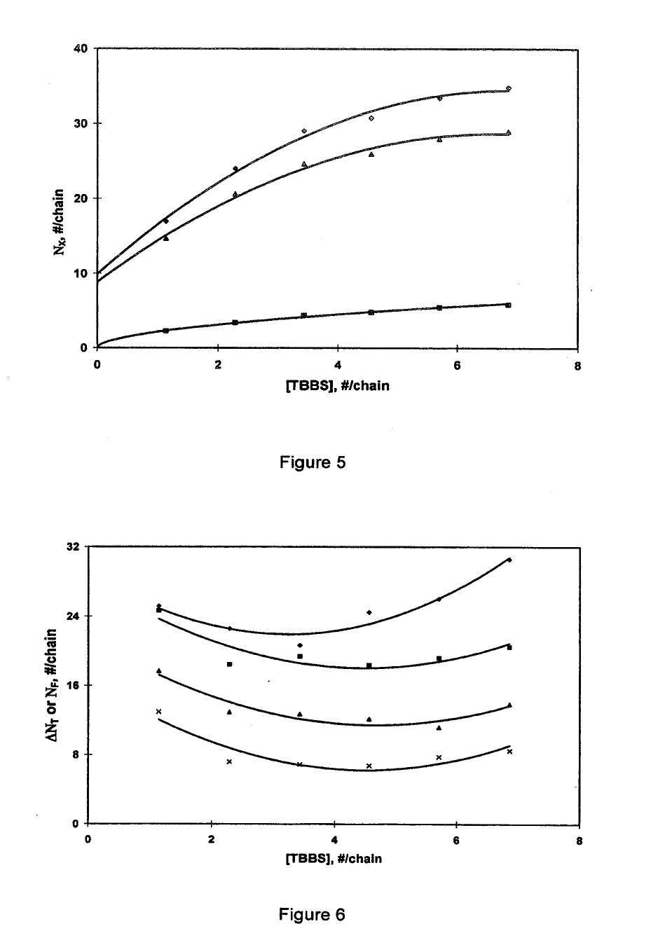

A plot of ΔN_{T} or N_{F(H)} versus [TBBS] is shown in FIG. 6. N_{F(H)} shows systematically greater values with increasing filler loading. The N_{F(H)} calculated shows a slight minimum for all four carbon black levels. It is theorized that perhaps the crosslinking reaction rate competes with the rate in which the chain interactions are established with the carbon black. To a first approximation, N_{F(H)} may be considered as constant independent of [TBBS]. The N_{F(H)} determined will be used when the contribution of terminal difunctional polymer reacting with filler (N_{F(Sn)}) is determined.

Model for Terminal Difunctional Polymers

For polymers containing functional end groups that can react with fillers, the entanglement model of Eq. 7 is further modified to allow for the reaction of either one or two ends of the polymer with the filler. The expanded form of this equation now becomes Eq, 8.

N_{T}=N_{C}+N_{E}+N_{F(Sn)}+N_{R} (8)

The new term (N_{R}) is the number of functional endgroups on a polymer molecule that react with the filler, and the more complex contribution between the filler and tin functionality is expressed as N_{F(Sn)}. To solve Eq. 8, the probability of reaction of the functional end group with filler is considered. For this modification, the value of the φₜ term initially introduced in Eq. 3, now must take the form of φ_{t,1} for one polymer end reacting with filler to give Eq. 9.

$${φ}_{t , 1} = {( \frac{n}{n + 1} )}^{2} \qquad ( 9 )$$

In the case where both functional ends react with filler, the value of the φ_{t,2} term is unity. Using the appropriate new form of φ_{t,i}, where i=1 or 2, the values of N_{E,1} and N_{E,2} (number of entanglements trapped/polymer molecule for the reaction of one and two chain ends, respectively) can now be calculated using the same procedure as was employed previously to determine values of N_{C}. For B, a slightly different function for n, n=2.944[TBBS]^{0.5228}, was found when a Mₑ of 3.20 kg/mol was used. Alternately, a single relationship can be written for both polymers where n=3.134[TBBS]^{0.4736} and an average Mₑ of 3.17 kg/mol was used. No apparent loss of information was seen by this approach. However, for greater precision, separate relations of n to [TBBS] for A and B were used. The value of N_{R} was assigned as 1 and 2 when used with N_{E,1} and N_{E,2}, respectively. The appropriate equations for this relationship are shown in Eqns. 10 or 11, where the values of the N_{R} discussed above were chosen for the reaction of one or two functional end groups, respectively.

N_{T}=N_{C}+N_{E,1}+N_{F(Sn)}+1 (10)

N_{T}=N_{C}+N_{E,2}+N_{F(Sn)}+2 (11)

Eq. 10 contains the terms used to describe N_{T} when only those polymer molecules with one end attached to a carbon black aggregate are formed. Eq. 11 is the relationship used for N_{T} where those polymer molecules with both ends attached to carbon black are considered. Replacing N_{E,1} in Eq. 10 with its relation to Mₑ and φ_{t,1}, and otherwise rearranging the equation gives Eq. 12.

$${N}_{T , 1} - {N}_{C} = {N}_{F ( Sn )} + ( \frac{{M}_{n}}{{M}_{e}} - 1 ) {( \frac{n}{n + 1} )}^{2} + 1 \qquad ( 12 )$$

Similarly, replacing N_{E,2} in Eq. 11 with its relation to Me and φ_{t,2}, where φ_{t,2}=1, gives Eq. 13.

$${N}_{T , 2} - {N}_{C} = {N}_{F ( Sn )} + ( \frac{{M}_{n}}{{M}_{e}} - 1 ) + 2 \qquad ( 13 )$$

Finally, N_{E} corresponding to no polymer chain ends reacting with carbon black (determined above) is defined as N_{E,0}, which is the same as Eq. 6. The three values of N_{E,0},N_{E,1} and N_{E,2} calculated from Eqns. 6, 12 and 13 can then be multiplied by their individual filler reaction probabilities that occur with a di-functional polymer. This results in the probability relationship of Eq. 14,

N_{T}−N_{C}=π²(N_{F(Sn)}+N_{E,2}+2)+2π(1−π)(N_{F(Sn)}+N_{E,1}+1)+(1−π)²(N_{F(Sn)}+N_{E,0}), (14)

where π is the probability that the end of a single polymer molecule would be attached to carbon black. Eq. 14 may be rearranged to give it as a function of N_{F(Sn)}, N_{E,0}, N_{E,1}, N_{E,2}, N_{T}, and N_{C}. All of these terms with the exception of N_{T}, which is experimentally measured, and N_{F(Sn)}, which is unknown, can be computed from Mₑ and n.

TABLE V
Conventional Physical Properties of Polymer A at 25° C.

| TBBS, phr | | | | | |
|---|---|---|---|---|---|
| 0.17 | 0.33 | 0.50 | 0.67 | 0.83 | 1.00 |

57.2 phr, CB

| | | | | | | |
|---|---|---|---|---|---|---|
| 300 Mod, MPa | 0.00 | 6.64 | 9.76 | 13.40 | 17.11 | 13.23 |
| T_{b}, MPa | 2.94 | 10.31 | 18.37 | 19.02 | 22.45 | 21.48 |
| E_{b}, % | 282 | 505 | 522 | 395 | 372 | 316 |
| tan δ @ 7% E | 0.199 | 0.1959 | 0.1945 | 0.1928 | 0.1893 | 0.1798 |
| ΔG′, MPa | 4.229 | 3.719 | 4.062 | 3.998 | 4.427 | 4.963 |

43.2 phr, CB

| | | | | | | |
|---|---|---|---|---|---|---|
| 300 Mod, MPa | 0.00 | 3.72 | 7.28 | 8.12 | 10.22 | 13.86 |
| T_{b}, MPa | 1.27 | 7.60 | 15.93 | 14.04 | 15.94 | 18.32 |
| E_{b}, % | 168 | 757 | 549 | 436 | 409 | 366 |
| tan δ @ 7% E | 0.1787 | 0.1642 | 0.1558 | 0.1571 | 0.1381 | 0.1292 |
| ΔG′, MPa | 1.832 | 1.402 | 1.505 | 1.755 | 1.363 | 1.421 |

30.7 phr, CB

| | | | | | | |
|---|---|---|---|---|---|---|
| tan δ @ 7% E | 0.1571 | 0.1363 | 0.1288 | 0.118 | 0.1108 | 0.0972 |
| ΔG′, MPa | 0.434 | 0.369 | 0.418 | 0.492 | 0.44 | 0.441 |

19.4 phr, CB

| | | | | | | |
|---|---|---|---|---|---|---|
| tan δ @ 7% E | 0.1517 | 0.1279 | 0.1111 | 0.0976 | 0.0882 | 0.0809 |
| ΔG′, MPa | 0.275 | 0.169 | 0.161 | 0.144 | 0.179 | 0.248 |

0 phr, CB

| | | | | | | |
|---|---|---|---|---|---|---|
| 300 Mod, MPa | 0.00 | 0.76 | 1.04 | 1.30 | 1.43 | 0.00 |
| Tb, MPa | 0.62 | 1.12 | 1.25 | 1.46 | 1.57 | 1.54 |
| E_{b}, % | 250 | 687 | 389 | 355 | 330 | 273 |
| tan δ @ 7% E | 0.1341 | 0.1313 | 0.0924 | 0.078 | 0.0668 | 0.0604 |
| ΔG′, MPa | | | 0.056 | 0.048 | 0.056 | 0.08 |

TABLE VI
Conventional Physical Properties of Polymer B at 25° C.

| TBBS, phr | | | | | |
|---|---|---|---|---|---|
| 0.17 | 0.33 | 0.50 | 0.67 | 0.83 | 1.00 |

57.2 phr, CB

| | | | | | | |
|---|---|---|---|---|---|---|
| 300 Mod, MPa | 4.36 | 7.24 | 9.75 | 15.84 | 18.66 | 0.00 |
| T_{b}, MPa | 7.46 | 17.64 | 21.04 | 25.37 | 24.28 | 22.33 |
| E_{b}, % | 528 | 550 | 488 | 404 | 355 | 310 |
| tan δ @ 7% E | 0.1812 | 0.1728 | 0.1664 | 0.1704 | 0.1604 | 0.1505 |
| ΔG′, MPa | 2.287 | 2.579 | 2.405 | 2.254 | 1.836 | 2.962 |

43.2 phr, CB

| | | | | | | |
|---|---|---|---|---|---|---|
| 300 Mod, MPa | 2.29 | 4.83 | 7.22 | 10.63 | 13.61 | 15.89 |
| T_{b}, MPa | 3.53 | 13.32 | 15.49 | 15.48 | 16.60 | 17.26 |
| Eb, % | 546 | 572 | 453 | 368 | 334 | 311 |
| tan δ @ 7% E | 0.1449 | 0.1325 | 0.1178 | 0.1078 | 0.0998 | 0.0955 |
| ΔG′, MPa | 0.608 | 0.606 | 0.609 | 0.619 | 0.647 | 0.613 |

30.7 phr, CB

| | | | | | | |
|---|---|---|---|---|---|---|
| tan δ @ 7% E | 0.1393 | 0.1265 | 0.1047 | 0.095 | 0.0812 | 0.069 |
| ΔG′, MPa | 0.228 | 0.226 | 0.241 | 0.222 | 0.21 | 0.179 |

19.4 phr, CB

| | | | | | | |
|---|---|---|---|---|---|---|
| Tan δ @ 7% E | 0.1376 | 0.1136 | 0.0983 | 0.0838 | 0.0821 | 0.0622 |
| ΔG′, MPa | 0.12 | 0.161 | 0.117 | 0.112 | 0.101 | 0.106 |

0 phr, CB

| | | | | | | |
|---|---|---|---|---|---|---|
| 300 Mod, MPa | 0.43 | 0.80 | 1.08 | 1.32 | 1.26 | 0.00 |
| Tb, MPa | 0.61 | 1.61 | 3.26 | 2.51 | 2.29 | 1.84 |
| Eb, % | 916 | 849 | 473 | 364 | 332 | 267 |
| tan δ @ 7% E | 0.1419 | 0.101 | 0.08 | 0.064 | 0.055 | 0.051 |
| ΔG′, MPa | 0.078 | 0.027 | 0.026 | 0.016 | 0.023 | 0.017 |

The relationship of the β intercept from TR is known to relate mix energy and efficiency of dispersing aids in cured elastomers. See U.S. Pat. No. 6,384,117, Hergenrother et al. herein incorporated by reference in its entirety. The values of β have the advantage that they were determined at the same time as the M_{c} and by the same method. Observing the β values listed in Table III suggests that as β increased in the presence of the functional polymers and CB, the number of chain restrictions due to filler also decreased.

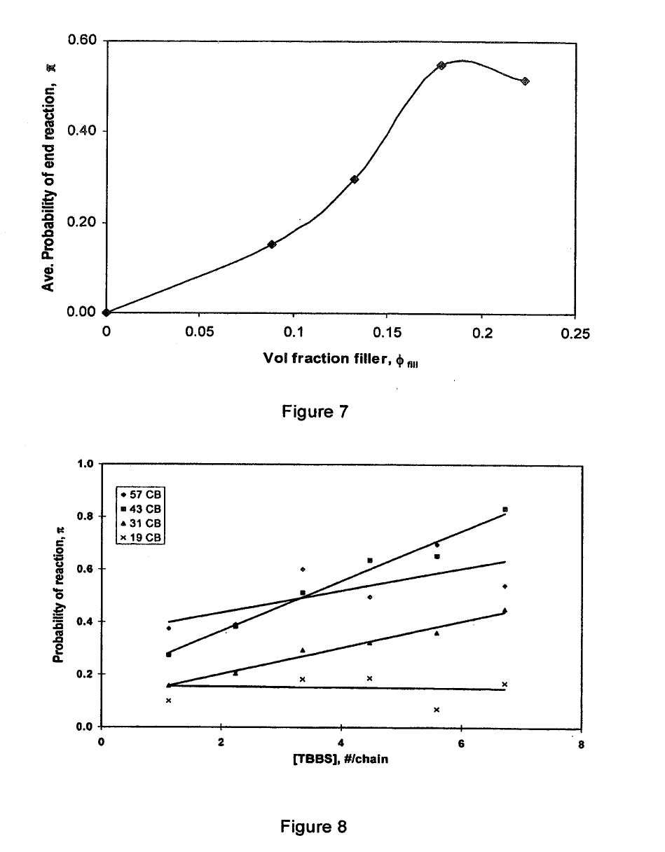

The following was used to assign the value of N_{F(Sn)}. The ratio of the β intercepts for Polymers A to B (β_{A}/β_{B}) was determined at each CB and cure level. These β ratios were then used to approximate the N_{F(Sn)} by multiplying with the corresponding N_{F(H)} that had already been determined for Polymer A. An average β ratio for each CB level, independent of [TBBS], or the individual β for each cure state could be used in the subsequent step. These N_{F(Sn)} values now all were lower than the N_{F(H)} that were measured for each corresponding non-functional sample. When they were substituted into Eqn 14 and Eqn 14 was solved for it by using Excel Goal Seek®, this produced π values between zero and one. The average it obtained for each φ_{fil} can be seen in FIG. 7.

The average probability of a reaction occurring at the tin end group was plotted to show a smooth increase with the volume fraction of CB in the cured sample. The values of 0.53 and 0.52 for the two highest levels of filler suggests that a plateau value has been obtained. The highest filler level stocks show that the ΔG′ was increased proportionately more with the last increase of the filler level, suggesting that an over filled condition could have resulted and thereby made this last point less accurate. Alternately, the scatter in FIG. 7 when a straight line is fit to the points may simple reflect experimental error, or errors introduced by the approximations that have been introduced.

A linear increase in it with increasing filler loading and a near zero intercept is also shown. This relationship indicates that the reactivity is a measure of the chemical interaction of the allyltin end groups with the ortho-quinone structure of the CB. This increase in π with increasing φ_{fil} was determined by multiplying the ratio of the β intercepts from TR by the N_{F(H)} term.

The individual values of π obtained can be seen (FIG. 8) to increase with increasing levels of [TBBS]. This was unexpected when considering only a reaction of filler and end group. The increase of π with [TBBS] suggests that the accelerator or active intermediate from the accelerator (t-butyl amine, benzothiazole or TBBS associated with zinc) could be forming a complex that gives some enhancement of the reaction of the allyl tin endgroup with the quinone functionality on the carbon black surface. The slope of the π plot is of interest in that at the lowest CB level there is little change in reactivity with increase in [TBBS]. The next two levels of CB are almost parallel to each other and steeper than the 19 CB level. The 57 phr CB level appears to be less sensitive to increases in [TBBS] than the lower CB loadings and has a larger scatter from linearity. Possibly this is caused by a slight overloading of the filler at the highest CB level. Almost identical results were seen when the individual β ratios were used in this treatment.

Comparison of Results

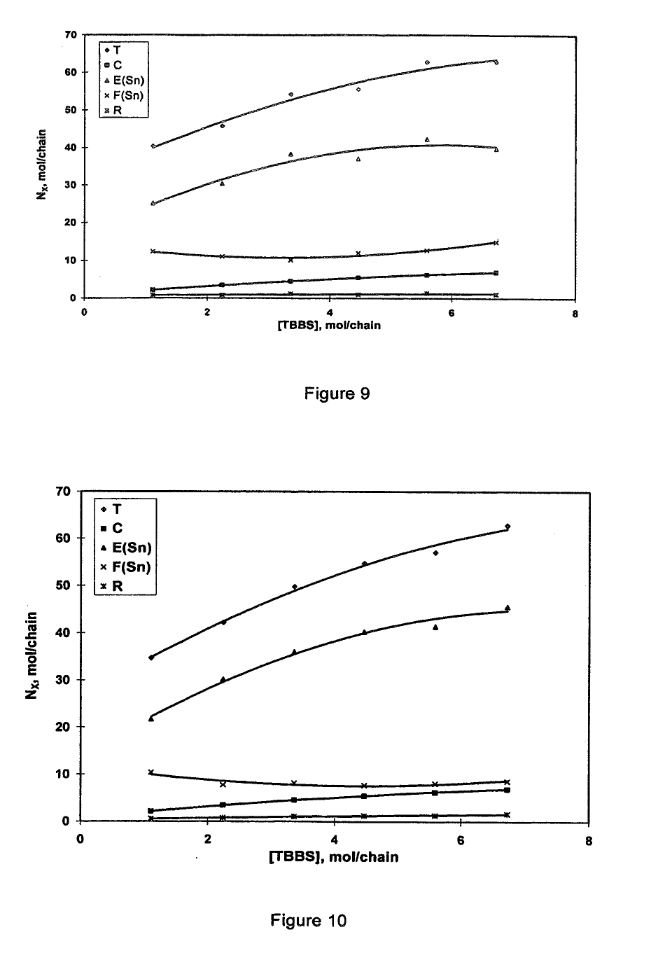

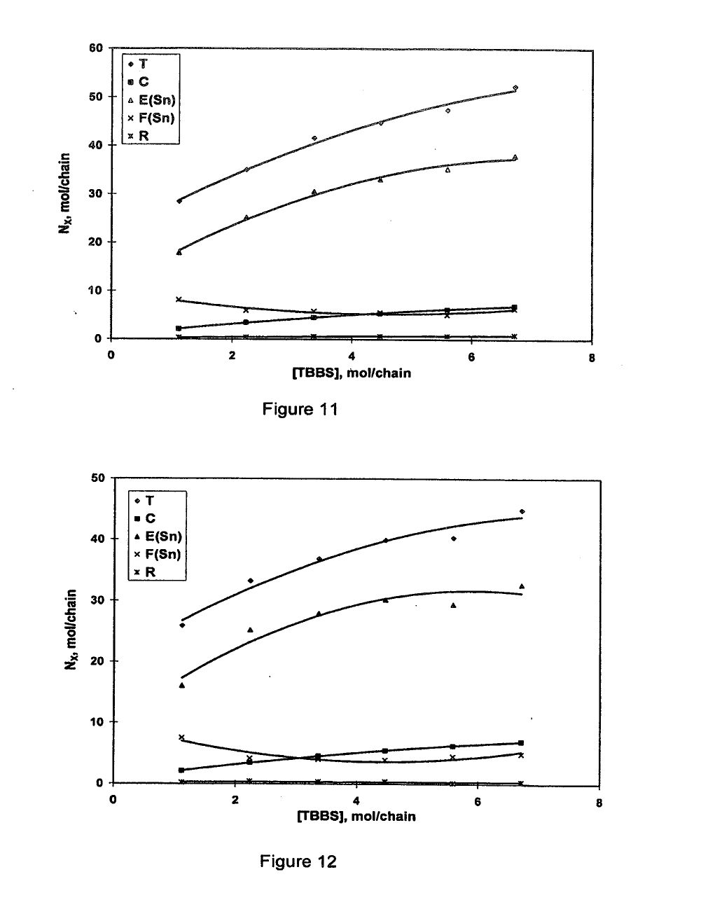

FIGS. 9 to 12 show how the various crosslinking processes contribute to the overall makeup of the cured functional SBR at different loadings of CB. All of these figures show the expected low contribution of N_{R} to the total number of effective network chains/polymer chain. The contribution from N_{F} increased steadily from 19 to 57 phr CB. The N_{E} was surprisingly high and was a significant contributor to the N_{T} at all CB loading. N_{C} was constant in all of the stocks at each [TBBS] level, but because of the reduction of the other types of effective network chains as the filler level was reduced, N_{C} contributed a higher fraction of N_{T} at lower CB loading.

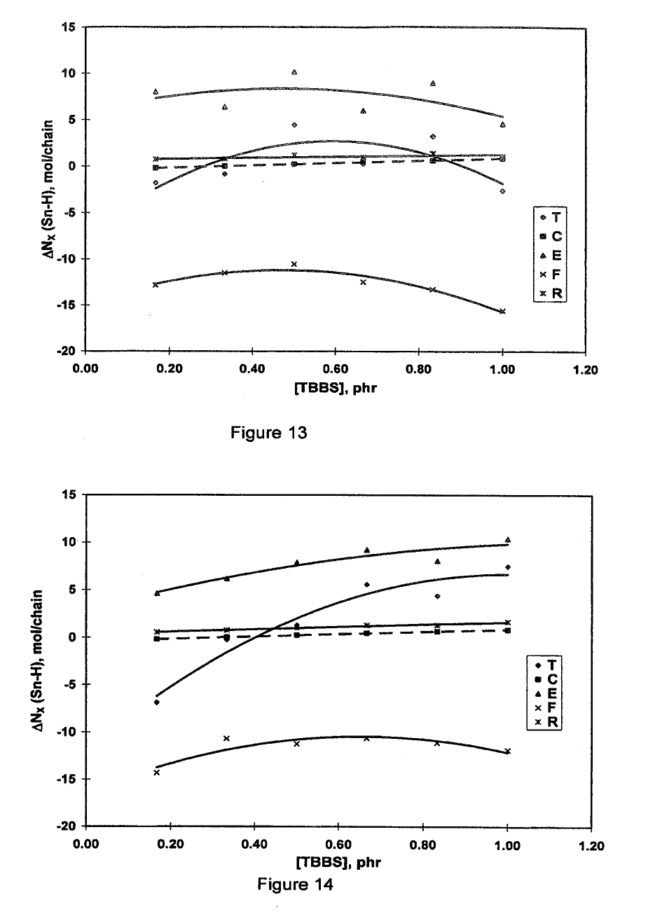

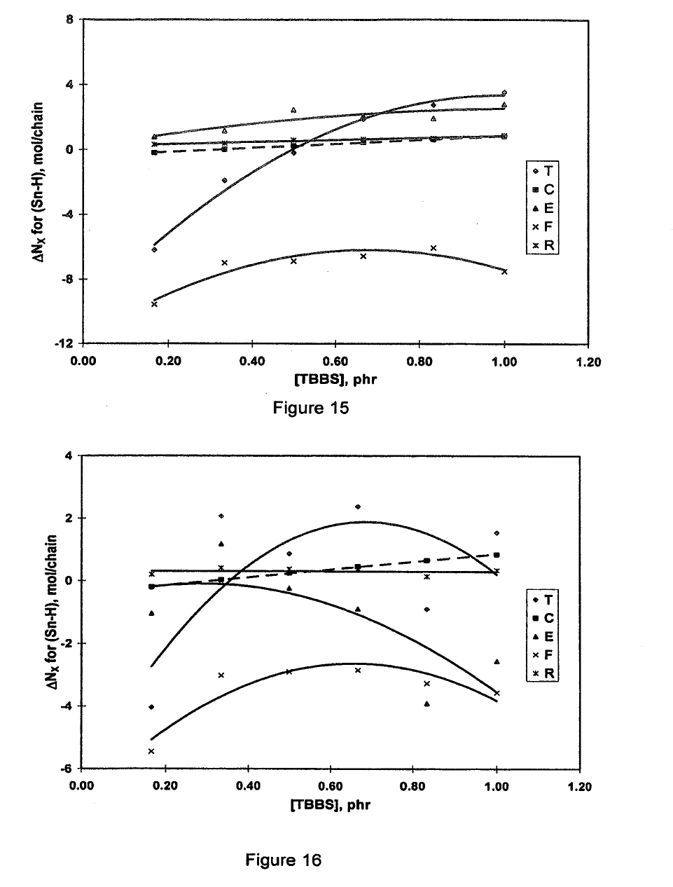

The effective network chains/polymer chain measured for polymer A, may be subtracted from the values for functional polymer B to determine the contribution due to the functionality in polymer A. See FIGS. 13 to 16. Here the data ΔNₓ (where x can be T, C, E, F and R) is plotted versus the phr loading of the TBBS. The small change in concentration of the accelerator in the two slightly different molecular weight polymers was not deemed to be relevant for this comparison. Now, the contributions to the ΔN_{X} values are readily seen and small changes are more obvious, allowing an insight into the enhanced physical properties that have been observed with B. For all CB levels, the changes observed in N_{C} and N_{R} from Sn—Sn to H—H are small and positive. The most striking feature of these plots may be the changes in N_{E} and N_{F} values, which are a direct result of the reaction of the functional end with the CB.

Preferred Embodiments

In one embodiment, this invention relates to a method of optimizing a tread compound, comprising the steps of: (a) providing a rubber composition comprising at least one functionalized polymer and at least one filler; (b) creating at least one set of tensile retraction curves, each set comprising at least two tensile retraction curves from the rubber composition, wherein said curves are generated from elongation values ranging from about 0.5% elongation to a maximum elongation of about 10% less than the elongation at break; and (c) calculating rubber composition factors from the set of tensile retraction curves, wherein the rubber composition factors comprise a trapped entanglements value (N_{E}), a chemical crosslink value (N_{C}), and a filler-filler-polymer interaction value (N_{F}). Preferably, each set of tensile retraction curves comprises at least three tensile retraction curves, more preferably, each set of tensile retraction curves comprises at least four tensile retraction curves.

With this method, a skilled artisan can calculate the probability (π) that one chain end of the polymer reacts with the filler; calculate the number of chain ends that react with the filler (N_{R}); and calculate the probability (π²) that both chain ends react with the filler.

The method may further comprise the step of, after the creating step, calculating the molecular weight between chain restrictions for each maximum individual elongation used. The molecular-weight-between-chain-restrictions calculation may be determined from the equation

$${M}_{r} = \frac{ρ RT ( Λ - {Λ}^{- 2} )}{σ} ,$$

where ρ is the compound density, σ is stress, R is the gas constant, T is temperature, and Λ is l+Xε, where X is the strain amplification factor from the Guth-Gold equation and the strain, ε, is (l−lₛₑₜ)/lₛₑₜ, where l is the specimen length at a point on the retraction curve, and lₛₑₜ is the specimen length after retraction to zero stress.

The method may further comprise the step of, after the molecular-weight calculation step, adjusting to the same testing rate the data sets of (i) the molecular weight between chain restrictions, and (ii) the maximum elongation.

The method may further comprise the step of, after the adjusting step, mathematically representing the data sets. Alternatively, the method may further comprise the step of, after the adjusting step graphically representing the data sets through the plotting of a smooth curve. After the plotting of the smooth curve, the data from the set of tensile retraction curves may be fit to determine the intercepts and slopes for the linearized segments of three regions of the curve. After the data has been fit to the curve, the filler content, state of cure, and presence of end-functionality may be varied to determine the effect on the intercepts.

In another embodiment, this invention relates to a method of preparing an end-functionalized polymer for use in an optimized tread compound, the method comprising the steps of: (a) providing a rubber composition comprising at least one functionalized polymer and at least one filler; (b) creating at least one set of tensile retraction curves, each set comprising at least two tensile retraction curves from the rubber composition, wherein said curves are generated from elongation values ranging from about 0.5% elongation to a maximum elongation of about 10% less than the elongation at break; (c) calculating from the set of tensile retraction curves at least one rubber composition factor, wherein the rubber composition factors comprise a trapped entanglements value (N_{E}), a chemical crosslink value (N_{C}), and a filler-filler-polymer interaction value (N_{F}); and (d) preparing a end-functionalized polymer for use in an optimized tread, wherein at least one of the rubber composition factors has been used to develop the end-functionalized polymer. Preferably, each set of tensile retraction curves comprises at least three tensile retraction curves, more preferably, each set of tensile retraction curves comprises at least four tensile retraction curves.

With this method, a skilled artisan can calculate the probability (π) that one chain end of the polymer reacts with the filler; calculate the number of chain ends that react with the filler (N_{R}); and calculate the probability (π²) that both chain ends react with the filler.

The method further comprises the step of, after the creating step, calculating the molecular weight between chain restrictions (Mᵣ) for each maximum individual elongation used. The molecular-weight-between-chain-restrictions calculation may be determined by the equation

$${M}_{r} = \frac{ρ RT ( Λ - {Λ}^{- 2} )}{σ} ,$$

where ρ is the compound density, σ is stress, R is the gas constant, T is temperature, and Λ is 1+Xε, where X is the Guth-Gold equation and the strain, ε, is (l−lₛₑₜ)/lₛₑₜ, where l is the specimen length at a point on the retraction curve, and lₛₑₜ is the specimen length after retraction to zero stress.

The method further comprises the step of, after the molecular-weight calculation step, adjusting to the same testing rate the data sets of (i) the molecular weight between chain restrictions, and (ii) the maximum elongation.

The method may further comprise the step of, after the adjusting step, mathematically representing the data sets. Alternatively, the method may further comprise the step of, after the adjusting step graphically representing the data sets through the plotting of a smooth curve. After the plotting of the smooth curve, the data from the set of tensile retraction curves may be fit to determine the intercepts and slopes for the linearized segments of three regions of the curve. After the data has been fit to the curve, the filler content, state of cure, and presence of end-functionality may be varied to determine the effect on the intercepts.

The polymer may be a non-functional polymer, wherein the trapped entanglements, chemical crosslinks, and filler-filler-polymer interactions are calculated and used to optimize the tread. Alternatively, the polymer may be a monofunctional or difunctional polymer, where the trapped entanglements, chemical crosslinks, filler-filler-polymer interactions, and the number of chain end functionality attachments to the filler are calculated and used to optimize the tread.

In another embodiment, this invention relates to a method of preparing an optimized tread compound, the method comprising the steps of: (a) providing a rubber composition comprising at least one functionalized polymer and at least one filler; (b) creating at least one set of tensile retraction curves, each set comprising at least two tensile retraction curves from the rubber composition, wherein said curves are generated from elongation values ranging from about 0.5% elongation to a maximum elongation of about 10% less than the elongation at break; (c) calculating the molecular weight between chain restrictions (Mᵣ) from the equation

$${M}_{r} = \frac{ρ RT ( Λ - {Λ}^{- 2} )}{σ}$$

for each maximum individual elongation used, wherein ρ is the compound density, σ is stress, R is the gas constant, T is temperature, and Λ is 1+Xε, wherein X is the Guth-Gold equation and the strain, ε, is (l−lₛₑₜ)/lₛₑₜ, wherein l is the specimen length at any point on the retraction curve, and lₛₑₜ is the specimen length after retraction to zero stress; (d) plotting a smooth curve from the data sets of Mr and maximum elongation that have all been adjusted to the same testing rate; (e) fitting the data from the tensile retraction curve to the equation

$${M}_{r} = \frac{1}{\frac{1}{β} ( {10}^{m ( Λ max - 1 )} ) + \frac{1}{γ} ( {10}^{n ( Λ max - 1 )} ) + \frac{1}{{M}_{C} + S ( {Λ}_{max} - 1 )}}$$

wherein Mᵣ and Λₘₐₓ−1 are described above, and the parameters β, γ and M_{c}, and m, n and S, correspond to intercepts and slopes, respectively, for linearized segments of three regions of the curve represented by the equation above, to obtain values for the β, γ, and M_{c} intercepts; (f) varying filler content, state of cure, and presence of end-functionality and determining the effect of each β, γ, and M_{c} to isolate contributions resulting from trapped entanglements (N_{E}), chemical crosslinks (N_{C}), filler-filler-polymer interactions (N_{F}), the number of end-functionality attachments to filler (N_{R}); and the probability π that an end is attached to the filler; (g) employing N_{R}, N_{E}, N_{C} and N_{F} to calculate the probability (π²) that a difunctional polymer is reacted at both ends; and (h) providing an optimized tread compound.

In another embodiment, this invention relates to a method of optimizing a tread compound, the method comprising the steps of: (a) providing a rubber composition comprising an end-difunctionalized polymer and at least one filler; (b) creating at least one set of tensile retraction curves, each set comprising at least two tensile retraction curves from the rubber composition, where said curves are generated from elongation values ranging from about 0.5% elongation to a maximum elongation of about 10% less than the elongation at break; (c) calculating the molecular weight between chain restrictions (Mᵣ) from the equation

$${M}_{r} = \frac{ρ RT ( Λ - {Λ}^{- 2} )}{σ}$$

for each maximum individual elongation used wherein ρ is the compound density, σ is stress, R is the gas constant, T is temperature, and Λ is 1+Xε, wherein X is the Guth-Gold equation and the strain, ε, is (l−lₛₑₜ)/lₛₑₜ, wherein l is the specimen length at any point on the retraction curve, and lₛₑₜ is the specimen length after retraction to zero stress; (d) plotting a smooth curve from the data sets of Mᵣ and maximum elongation after they have all been adjusted to the same testing rate; (e) statistically fitting a Mᵣ=S (Λₘₐₓ−1)+M_{c} line to the highest elongation region (Region I) by successively adding the next lowest elongation data set of the curve obtained in step (d), such that R (squared) is greater than 0.98; (f) subtracting the crosslink density (νₑ) predicted from the equation fitted to Region I from the measured νₑ corresponding to the remainder of the low elongation region of the data curve plotted in step (d) to obtain (Δνₑ); (g) plotting a smooth curve from the logarithm of Δνₑ of the data set vs. the remaining elongations; (h) statistically fitting a log Δνₑ=s(Λₘₐₓ−1)+m line by starting at the highest remaining elongation region (Region II) and successively adding the next lowest elongation data set of the curve such that R (squared) is greater than 0.98; (i) subtracting the values of Δνₑ calculated from the equation fitted in Region II from the Δνₑ measured for the remainder of the low elongation region of the data set (ΔΔνₑ); (j) plotting a smooth curve from the logarithm of ΔΔνₑ determined in step (i) vs. the remaining elongations; (k) statistically fitting a log ΔΔνₑ=t(Λₘₐₓ−1)+n starting with the highest remaining elongation region (Region III) by successively adding the next lowest elongation data set of the curve such that R (squared) is greater than 0.98; (l) calculating the total number of effective network strands, N_{T}, from the number average molecular weight of the original polymer (Mₙ) and density (ρ), wherein N_{T}=νₑMₙ/ρ from each M_{c} intercepts of Region I; (m) plotting the N_{T} for each filler level used vs. the concentration of accelerator [acc]; (n) plotting the log ΔΔνₑ intercepts from Region III of the gum cured rubbers vs. [acc] and determining the molecular weight between entanglements, Mₑ by statistically fitting the equation of y=dx²+ex+f wherein the zero [acc] intercept f is used to calculate Mₑ=1/10^{f}; (o) calculating the trapped entanglements value for the cured unfilled polymer as

$${N}_{E} = {( \frac{n - 1}{n + 1} )}^{2} ( \frac{{M}_{n}}{{M}_{e}} - 1 )$$

wherein n is the number of chemical bounds formed during cure; (p) plotting

$${N}_{T} = ( n - 1 ) + ( \frac{{M}_{n}}{{M}_{e}} - 1 ) {( \frac{n - 1}{n + 1} )}^{2}$$

vs. [acc] the value of n as a function of [acc] can be determined by fitting to the equation n=a[acc]^{b}; (q) subtracting the sum value of N_{T} from the filled value of N_{T} to generate the contribution of the filler N_{F(H)} to the cured rubber; (r) repeating the above steps with an α, ω-difunctional polymer and the equation N_{T}=N_{C}+N_{E}+N_{F(func)}+N_{R} to account for the end group reacting with filler, N_{R}, the change that this reaction causes in the contribution to the filler on crosslinking, N_{F(func)}, and the three different contributions of N_{E} that account for trapping of entanglements; wherein, for one and two end groups reacting with filler, the new equations become

$${N}_{T , 1} - {N}_{c} = {N}_{F ( func )} + ( \frac{{M}_{n}}{{M}_{e}} - 1 ) {( \frac{n}{n + 1} )}^{2} + 1$$

$$and$$

$${N}_{T , 2} - {N}_{C} = {N}_{F ( func )} + ( \frac{{M}_{n}}{{M}_{e}} - 1 ) + 2 ,$$

respectively, and use the equation

$${N}_{T , 0} - {N}_{c} = {N}_{F ( func )} + ( \frac{{M}_{n}}{{M}_{e}} - 1 ) {( \frac{n - 1}{n + 1} )}^{2}$$

where no polymer end groups react with filler; (s) calculating β=1/10^{m} from Region II as a measure of the filler contribution to the crosslinked network; (t) calculating the new N_{F(func)} as the beta ratio of the non-functional polymer to the α, ω-difunctional polymer times the N_{F(H)}; (u) solving the equation weighted for the filler reaction of N_{T}−N_{C}=π²(N_{F(func)}+N_{E,2}+2)+2π(1−π)(N_{F(func)}+N_{E,1}+1)+(1−π)²(N_{F(func)}+N_{E,0}) for the probability (π) that a chain end reacts with the filler; and (ν) optimizing the probability (π²) that a polymer has reacted at both ends with filler by selecting the type of functional group, filler type, accelerator type, mixing and curing conditions to give the lowest values for abrasion resistance and rolling resistance.

The invention also relates to a difunctional polymer wherein both ends of the difunctional polymer sufficiently react with a filler to produce a π² value of greater than about 0.04, where preferably, the π² value is greater than about 0.35. More preferably, the π² value is greater than about 0.50. The π² value is that defined above, where it is determined from the equation N_{T}−N_{C}=π²(N_{F(func)}+N_{E,2}+2)+2π(1−π)(N_{F(func)}+N_{E,1}+1)+(1−π)²(N_{F(func)}+N_{E,0}), where N_{T} is the total restrictions value, N_{C} is the chemical crosslink value, N_{F} is the filler-filler-polymer interaction value, N_{E} is the trapped entanglement value.

This invention also relates to a rubber composition comprising a polymer and a filler, the composition having (a) a trapped entanglement value (N_{E}) ranging from about 10 to 40 per polymer chain; (b) a chemical crosslink value (N_{C}) ranging from about 2 to 10 per polymer chain; and (c) a filler-filler-polymer interaction value (N_{F}) ranging from about 10 to 15 restrictions per polymer chain. The polymer may further comprise a chain end reactions value (π) ranging from about 0.2 to 0.95, where π is determined from the equation

N_{T}−N_{C}=π²(N_{F(func)}+N_{E,2}+2)+2π(1−π)(N_{F(func)}+N_{E,1}+1)+(1−π)²(N_{F(func)}+N_{E,0}).

The foregoing description of embodiments is provided to enable any person skilled in the art to make or use embodiments of the present invention. Various modifications to these embodiments are possible, and the generic principles presented herein may be applied to other embodiments as well. As such, the present invention is not intended to be limited to the embodiments shown above but rather is to be accorded the widest scope consistent with the principles and novel features disclosed in any fashion herein.

What is claimed is:

1. A method of optimizing a tread compound, comprising:
a. providing a rubber composition comprising at least one functionalized polymer and at least one filler;
b. creating at least one set of tensile retraction curves, each set comprising at least two tensile retraction curves from the rubber composition, wherein said curves are generated from elongation values ranging from about 0.5% elongation to a maximum elongation of about 10% less than the elongation at break; and
c. calculating rubber composition factors from the set of tensile retraction curves, wherein the rubber composition factors comprise a trapped entanglements value (N_{E}), a chemical crosslink value (N_{C}), and a filler-filler-polymer interaction value (N_{F}).

2. The method of claim 1, wherein each set of tensile retraction curves comprises at least three tensile retraction curves.

3. The method of claim 1, wherein each set of tensile retraction curves comprises at least four tensile retraction curves.

4. The method of claim 1, further comprising the step of calculating the probability (π) that one chain end of the polymer reacts with the filler.

5. The method of claim 4, further comprising the step of calculating the number of chain ends that react with the filler (N_{R}).

6. The method of claim 4, further comprising the step of calculating the probability (π²) that both chain ends react with the filler.

7. The method of claim 1, further comprising the step of, after the creating step, calculating the molecular weight between chain restrictions for each maximum individual elongation used.

8. The method of claim 7, wherein the molecular-weight-between-chain-restrictions calculation is determined from the equation
$${M}_{r} = \frac{ρ RT ( Λ - {Λ}^{- 2} )}{σ} ,$$
where ρ is the compound density, σ is stress, R is the gas constant, T is temperature, and Λ is l+Xε, where X is the strain amplification factor from the Guth-Gold equation and the strain, ε, is (l−lₛₑₜ)/iₛₑₜ, where l is the specimen length at a point on the retraction curve, and lₛₑₜ is the specimen length after retraction to zero stress.

9. The method of claim 7, further comprising the step of, after the molecular-weight calculation step, adjusting to the same testing rate the data sets of (i) the molecular weight between chain restrictions, and (ii) the maximum elongation.

10. The method of claim 9, further comprising the step of, after the adjusting step, mathematically representing the data sets.

11. The method of claim 9, further comprising the step of, after the adjusting step graphically representing the data sets through the plotting of a smooth curve.

12. The method of claim 11, further comprising the step of, after the plotting of the smooth curve, fitting the data from the set of tensile retraction curves to determine the intercepts and slopes for the linearized segments of three regions of the curve.

13. The method of claim 12, further comprising the step of, after the fitting step, varying the filler content, state of cure, and presence of end-functionality to determine the effect on the intercepts.

14. A method of preparing an end-functionalized polymer for use in an optimized tread compound, the method comprising:
a. providing a rubber composition comprising at least one functionalized polymer and at least one filler;
b. creating at least one set of tensile retraction curves, each set comprising at least two tensile retraction curves from the rubber composition, wherein said curves are generated from elongation values ranging from about 0.5% elongation to a maximum elongation of about 10% less than the elongation at break;
c. calculating from the set of tensile retraction curves at least one rubber composition factor, wherein the rubber composition factors comprise a trapped entanglements value (N_{E}), a chemical crosslink value (N_{C}), and a filler-filler-polymer interaction value (N_{F}); and
d. preparing a end-functionalized polymer for use in an optimized tread, wherein at least one of the rubber composition factors has been used to develop the end-functionalized polymer.

15. The method of claim 14, wherein each set of tensile retraction curves comprises at least three tensile retraction curves.

16. The method of claim 14, wherein each set of tensile retraction curves comprises at least four tensile retraction curves.

17. The method of claim 14, further comprising the step of, after the calculation step (c), calculating the probability (π) that one chain end of the polymer reacts with the filler.

18. The method of claim 17, further comprising the step of calculating the number of chain ends that react with the filler (N_{R}).

19. The method of claim 18, further comprising the step of, after the calculation of the chain end reactions value, calculating the probability (π²) that both chain ends react with the filler.

20. The method of claim 14, further comprising the step of, after the creating step, calculating the molecular weight between chain restrictions (Mᵣ) for each maximum individual elongation used.

21. The method of claim 20, wherein the molecular-weight-between-chain-restrictions calculation is determined by the equation
$${M}_{r} = \frac{ρ RT ( Λ - {Λ}^{- 2} )}{σ} ,$$
where ρ is the compound density, σ is stress, R is the gas constant, T is temperature, and Λ is 1+Xε, where X is the Guth-Gold equation and the strain, ε, is (l−lₛₑₜ)/lₛₑₜ, where l is the specimen length at a point on the retraction curve, and lₛₑₜ is the specimen length after retraction to zero stress.

22. The method of claim 20, further comprising the step of, after the molecular-weight calculation step, adjusting to the same testing rate the data sets of (i) the molecular weight between chain restrictions, and (ii) the maximum elongation.

23. The method of claim 22, further comprising the step of, after the adjusting step, mathematically representing the data sets.

24. The method of claim 22, further comprising the step of, after the adjusting step graphically representing the data sets through the plotting of a smooth curve.

25. The method of claim 23, further comprising the step of, after the plotting of the smooth curve, fitting the data from the set of tensile retraction curve to determine the intercepts and slopes for the linearized segments of three regions of the curve.

26. The method of claim 25, further comprising the step of, after the fitting step, varying the filler content, state of cure, and presence of end-functionality to determine the effect on the intercepts.

27. The method of claim 14, wherein the polymer is a monofunctional polymer.

28. The method of claim 14, wherein the polymer is a difunctional polymer.

29. A method of preparing an optimized tread compound, the method comprising:
a. providing a rubber composition comprising at least one functionalized polymer and at least one filler;
b. creating at least one set of tensile retraction curves, each set comprising at least two tensile retraction curves from the rubber composition, wherein said curves are generated from elongation values ranging from about 0.5% elongation to a maximum elongation of about 10% less than the elongation at break;
c. calculating the molecular weight between chain restrictions (Mᵣ) from the equation
$${M}_{r} = \frac{ρ RT ( Λ - {Λ}^{- 2} )}{σ} ,$$
for each maximum individual elongation used, wherein ρ is the compound density, σ is stress, R is the gas constant, T is temperature, and Λ is 1+Xε, wherein X is the Guth-Gold equation and the strain, ε, is (l−lₛₑₜ)/lₛₑₜ, wherein l is the specimen length at any point on the retraction curve, and lₛₑₜ is the specimen length after retraction to zero stress;
d. plotting a smooth curve from the data sets of Mr and maximum elongation that have all been adjusted to the same testing rate;
e. fitting the data from the tensile retraction curve to the equation
$${M}_{r} = \frac{1}{\frac{1}{β} ( {10}^{m ( Λ max - 1 )} ) + \frac{1}{γ} ( {10}^{n ( Λ max - 1 )} ) + \frac{1}{{M}_{C} + S ( {Λ}_{max} - 1 )}}$$
wherein Mᵣ and Λₘₐₓ−1 are described above, and the parameters β, γ and M_{c}, and m, n and S, correspond to intercepts and slopes, respectively, for linearized segments of three regions of the curve represented by the equation above, to obtain values for the β, γ, and M_{c} intercepts;
f. varying filler content, state of cure, and presence of end-functionality and determining the effect of each β, γ, and M_{c} to isolate contributions resulting from trapped entanglements (N_{E}), chemical crosslinks (N_{C}), filler-filler-polymer interactions (N_{F}), the number of end-functionality attachments to filler (N_{R}); and the probability π that an end is attached to the filler;
g. employing N_{R}, N_{E}, N_{C} and N_{F} to calculate the probability (π²) that a difunctional polymer is reacted at both ends; and
h. providing an optimized tread compound.

30. A method of optimizing a tread compound, the method comprising the steps of:
a. providing a rubber composition comprising an end-difunctionalized polymer and at least one filler;
b. creating at least one set of tensile retraction curves, each set comprising at least two tensile retraction curves from the rubber composition, where said curves are generated from elongation values ranging from about 0.5% elongation to a maximum elongation of about 10% less than the elongation at break;
c. calculating the molecular weight between chain restrictions (Mᵣ) from the equation
$${M}_{r} = \frac{ρ RT ( Λ - {Λ}^{- 2} )}{σ}$$
for each maximum individual elongation used wherein ρ is the compound density, σ is stress, R is the gas constant, T is temperature, and Λ is 1+Xε, wherein X is the Guth-Gold equation and the strain, ε, is (l−lₛₑₜ)/lₛₑₜ, wherein l is the specimen length at any point on the retraction curve, and lₛₑₜ is the specimen length after retraction to zero stress;
d. plotting a smooth curve from the data sets of Mᵣ and maximum elongation after they have all been adjusted to the same testing rate;
e. statistically fitting a Mᵣ=S(Λₘₐₓ−1)+M_{c} line to the highest elongation region (Region I) by successively adding the next lowest elongation data set of the curve obtained in step (d), such that R (squared) is greater than 0.98;
f. subtracting the crosslink density (νₑ) predicted from the equation fitted to Region I from the measured νₑ corresponding to the remainder of the low elongation region of the data curve plotted in step (d) to obtain (Δνₑ);
g. plotting a smooth curve from the logarithm of Δνₑ of the data set vs. the remaining elongations;
h. statistically fitting a log Δνₑ=s(Λₘₐₓ−1)+m line by starting at the highest remaining elongation region (Region II) and successively adding the next lowest elongation data set of the curve such that R (squared) is greater than 0.98;
i. subtracting the values of Δνₑ calculated from the equation fitted in Region II from the Δνₑ measured for the remainder of the low elongation region of the data set (ΔΔνₑ);
j. plotting a smooth curve from the logarithm of ΔΔνₑ determined in step (i) vs. the remaining elongations;
k. statistically fitting a log ΔΔνₑ=t(Λₘₐₓ−1)+n starting with the highest remaining elongation region (Region III) by successively adding the next lowest elongation data set of the curve such that R (squared) is greater than 0.98;
l. calculating the total number of effective network strands, N_{T}, from the number average molecular weight of the original polymer (Mₙ) and density (ρ), wherein N_{T}=νₑMₙ/ρ from each M_{c} intercepts of Region I;
m. plotting the N_{T} for each filler level used vs. the concentration of accelerator [acc];
n. plotting the log ΔΔνₑ intercepts from Region III of the gum cured rubbers vs. [acc] and determining the molecular weight between entanglements, Mₑ by statistically fitting the equation of y=dx²+ex+f wherein the zero [acc] intercept f is used to calculate Mₑ=1/10^{f};
o. calculating the trapped entanglements value for the cured unfilled polymer as
$${N}_{E} = {( \frac{n - 1}{n + 1} )}^{2} ( \frac{{M}_{n}}{{M}_{e}} - 1 )$$
wherein n is the number of chemical bounds formed during cure;
p. plotting
$${N}_{T} = ( n - 1 ) + ( \frac{{M}_{n}}{{M}_{e}} - 1 ) {( \frac{n - 1}{n + 1} )}^{2}$$
vs. [acc] the value of n as a function of [acc] can be determined by fitting to the equation n=a[acc]^{b};
q. subtracting the sum value of N_{T} from the filled value of N_{T} to generate the contribution of the filler N_{F(H)} to the cured rubber;
r. repeating the above steps with an α, ω-difunctional polymer and the equation N_{T}=N_{C}+N_{E}+N_{F(func)}+N_{R} to account for the end group reacting with filler, N_{R}, the change that this reaction causes in the contribution to the filler on crosslinking, N_{F(func)}, and the three different contributions of N_{E} that account for trapping of entanglements; wherein, for one and two end groups reacting with filler, the new equations become
$${N}_{T , 1} - {N}_{c} = {N}_{F ( func )} + ( \frac{{M}_{n}}{{M}_{e}} - 1 ) {( \frac{n}{n + 1} )}^{2} + 1$$
$$and$$
$${N}_{T , 2} - {N}_{C} = {N}_{F ( func )} + ( \frac{{M}_{n}}{{M}_{e}} - 1 ) + 2 ,$$
respectively, and use the equation
$${N}_{T , 0} - {N}_{c} = {N}_{F ( func )} + ( \frac{{M}_{n}}{{M}_{e}} - 1 ) {( \frac{n - 1}{n + 1} )}^{2}$$
where no polymer end groups react with filler;
s. calculating β=1/10^{m} from Region II as a measure of the filler contribution to the crosslinked network;
t. calculating the new N_{F(func)} as the beta ratio of the non-functional polymer to the α, ω-difunctional polymer times the N_{F(H)};
u. solving the equation weighted for the filler reaction of N_{T}−N_{C}=π²(N_{F(func)}+N_{E,2}+2)+2π(1−π)(N_{F(func)}+N_{E,1}+1)+(1−π)²(N_{F(func)}+N_{E,0}) for the probability (π) that a chain end reacts with the filler; and
v. optimizing the probability (π²) that a polymer has reacted at both ends with filler by selecting the type of functional group, filler type, accelerator type, mixing and curing conditions to give the lowest values for abrasion resistance and rolling resistance.

31. A difunctional polymer wherein both ends of the difunctional polymer sufficiently react with a filler to produce a π² value of greater than about 0.04, where π is determined from the equation N_{T}−N_{C}=π²(N_{F(func)}+N_{E,2}+2)+2π(1−π)(N_{F(func)}+N_{E,1}+1)+(1−π)²(N_{F(func)}+N_{E,0}), where N_{T} is the total restrictions value, N_{C} is the chemical crosslink value, N_{F} is the filler-filler-polymer interaction value, N_{E} is the trapped entanglement value.

32. The difunctional polymer of claim 31, wherein the π² value is greater than about 0.35.

33. The difunctional polymer of claim 31, wherein the π² value is greater than about 0.50.

34. A rubber composition comprising a polymer and a filler, the composition having (a) a trapped entanglement value (N_{E}) ranging from about 10 to 40 per polymer chain; (b) a chemical crosslink value (N_{C}) ranging from about 2 to 10 per polymer chain; and (c) a filler-filler-polymer interaction value (N_{F}) ranging from about 10 to 15 restrictions per polymer chain.

35. A rubber composition according to claim 34, wherein the polymer further comprises a chain end reactions value (π) ranging from about 0.2 to 0.95, where it is determined from the equation N_{T}−N_{C}=π²(N_{F(func)}+N_{E,2}+2)+2π(1−π)(N_{F(func)}+N_{E,1}+1)+(1−π)²(N_{F(func)}+N_{E,0}).
